(19) United States
(12) Patent Application Publication
(10) Pub. No.: US 2015/0318793 A1
(43) Pub. Date: Nov. 5, 2015

(54) CONVERTER APPARATUS

(71) Applicant: Masashi KOBAYASHI, (US)

(72) Inventor: Masashi KOBAYASHI, Gotenba-shi (JP)

(73) Assignee: TOYOTA JIDOSHA KABUSHIKI KAISHA, Toyota-shi, Aichi (JP)

(21) Appl. No.: 14/441,953

(22) PCT Filed: Nov. 7, 2013
(86) PCT No.: PCT/JP2013/080162

§ 371 Date: May 11, 2015

(30) Foreign Application Priority Data
Dec. 12, 2012 (JP) 2012-271390

(51) Int. Cl. H02M 7/537

(52) U.S. Cl. CPC H02M 7/537

(57) ABSTRACT

A converter apparatus is presented which includes a converter that includes a switching element and an inductor, a controller that sets a duty at a predetermined duty setting cycle, and executes an ON/OFF switching of the switching element of the converter at switching timing according to a relationship between the set duty and a carrier signal, the predetermined duty setting cycle corresponding to a half cycle of the carrier signal. The controller determines the duty to be set at this duty setting cycle such that sampling of a current value of a current flowing through the inductor and calculation of the duty to be set at the next duty setting cycle based on the sampled current value are completed before next duty setting timing.

### TECHNICAL FIELD

The present invention is related to a converter apparatus.

### BACKGROUND ART

A boost converter control apparatus is known which obtains an average value of an inductor current flowing through an inductor by sampling the inductor current at predetermined timing near a peak of a carrier (see Patent Document 1, for example).

Further, a way of calculating an average of a current flowing through the inductor is known which calculates the current value of the inductor at middle timing in an OFF period or an ON period of a switching element (see Patent Document 2, for example).

[Patent Document 1] Japanese Laid-open Patent Publication No. 2012-139084

[Patent Document 2] International Publication Pamphlet No. WO2010/061654

### DISCLOSURE OF INVENTION

### Problem to be Solved by Invention

A duty, which defines ON/OFF switching timing of a switching element of a converter apparatus, is determined based on an inductor current flowing through an inductor; however, appropriate sampling timing of sampling the inductor current for calculating the duty at the next cycle depends on the duty at this cycle. Thus, there may be a case, depending on the duty set at this cycle, that the appropriate sampling timing of sampling the inductor current is delayed. In such a case, there is a probability that the duty at the next cycle based on the sampled inductor current cannot be calculated before the next duty setting timing.

Therefore, an object of the present invention is to provide a converter apparatus that can calculate a duty such that a current value of an inductor is sampled at appropriate timing before next duty setting timing and the duty can be set at the next duty setting timing based on the sampled current value.

### Means to Solve the Problem

In order to achieve the object, according to an aspect of the present invention, a converter apparatus is provided, which includes:

a converter that includes a switching element and an inductor;

a controller that sets a duty at a predetermined duty setting cycle, and executes an ON/OFF switching of the switching element of the converter at switching timing according to a relationship between the set duty and a carrier signal, the predetermined duty setting cycle corresponding to a half cycle of the carrier signal, wherein
the controller determines the duty to be set at this duty setting cycle such that sampling of a current value of a current flowing through the inductor and calculation of the duty to be set at the next duty setting cycle based on the sampled current value are completed before next duty setting timing.

### Advantage of the Invention

According to the present invention, a converter apparatus can be obtained, which converter apparatus can calculate a duty such that a current value of an inductor is sampled at appropriate timing before next duty setting timing and the duty can be set at the next duty setting timing based on the sampled current value.

### BRIEF DESCRIPTION OF DRAWINGS

FIG. 1 is a diagram illustrating an example of an overview configuration of a motor drive system 1 for an electric vehicle.

FIG. 2 is a diagram illustrating an example of a control block 500 of a DC/DC converter 20 of a semiconductor drive apparatus 50.

FIG. 3 is a diagram illustrating an example of ON/OFF states of switching elements Q22 and Q24 that are switched based on a carrier signal and a duty.

FIG. 4 is a diagram illustrating an example of a way of determining sampling timing.

FIG. 5 is a diagram illustrating a relationship between respective sampling timings and values of a duty set based on sampled values of an inductor current IL obtained at the respective sampling timings.

FIG. 6 is a diagram for explaining an example of a way of correcting the duty in a duty correction part 512.

FIG. 7 is a diagram schematically illustrating a part of FIG. 5 to explain FIG. 6.

FIG. 8 is a diagram for explaining a way of correcting the duty under a lower limit value σ1 of the duty.

FIG. 9 is a diagram for explaining a way of correcting the duty under an upper limit value σ2 of the duty.

### DESCRIPTION OF REFERENCE SYMBOLS

1 motor drive system
10 battery
20 DC-DC converter
30 inverter
40 motor for driving a vehicle
50 semiconductor driver device
Q1, Q2 switching element related to U-phase
Q3, Q4 switching element related to V-phase
Q5, Q6 switching element related to W-phase
Q22 switching element of upper arm
Q24 switching element of lower arm
502 filter
504 ADC
506 current control part
508 voltage control part
510 motor target voltage calculation part
512 duty correction part
513 carrier generation part
514 gate signal generation circuit part
516 sampling timing calculation part
540 motor controlling part
560 travel control part

### BEST MODE FOR CARRYING OUT THE INVENTION

In the following, the best mode for carrying out the present invention will be described in detail by referring to the accompanying drawings.

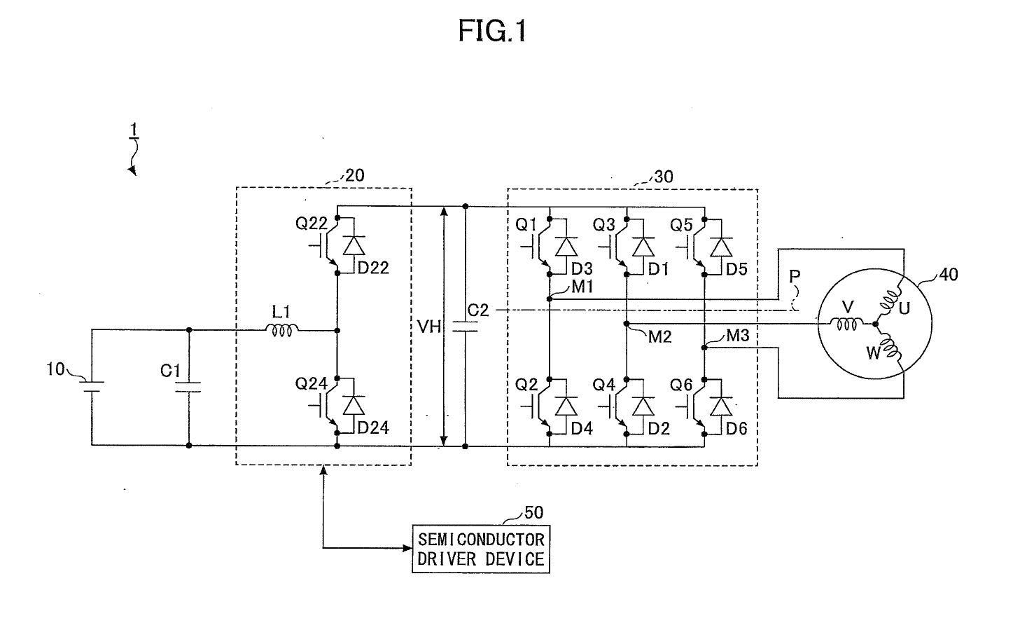

FIG. 1 is a diagram illustrating an example of an overview configuration of a motor drive system 1 for an electric vehicle. The motor drive system 1 is a system for driving a motor 40 for driving a vehicle using power from a battery 10. It is noted that a type of the electric vehicle or a detailed configuration of the electric vehicle may be arbitrary as long as the electric vehicle is driven with a motor 40 using electric power. Typically, the electric vehicle includes a hybrid vehicle (HV) which uses an internal combustion engine and the motor 40 as power sources and a genuine electric vehicle which uses the motor 40 only as a power source.

The motor drive system 1 includes the battery 10, a DC-DC converter 20, an inverter 30, the motor 40 and a semiconductor driver device 50, as shown in FIG. 1.

The battery 10 is an arbitrary capacitor cell which accumulates power to output a direct-current voltage. The battery 10 may be configured as a nickel hydrogen battery, a lithium ion battery or a capacitive element such as an electrical double layer capacitor, etc.

The DC-DC converter 20 may be a bidirectional DC-DC converter (a reversible chopper type DC-DC converter). The DC/DC converter 20 may be capable of performing a step-up conversion of 200 V to 650 V, and a step-down conversion of 650 V to 200 V, for example. A smoothing capacitor C1 may be connected between an input side of an electric inductor L1 of the DC-DC converter 20 and a negative electrode line.

In the illustrated example, the DC/DC converter 20 includes two switching elements Q22 and Q24, and the inductor L1. The switching elements Q1 and Q2 are connected in series between a positive side line and a negative side line of the inverter 30. The inductor L1 is connected in series to the positive side of the battery 10. The inductor L1 has an output side connected to a connection point between the switching elements Q22 and Q24.

In the illustrated example, the switching elements Q22 and Q24 of the DC/DC converter 20 are IGBTs (Insulated Gate Bipolar Transistors). It is noted that the switching elements Q22 and Q24 may be ordinary IGBTs which include diodes (freewheel diodes, for example) D22 and D24 that are externally provided, or RC (Reverse Conducting)-IGBTs that internally include the diodes D22 and D24. In any case, a collector of the switching element Q22 of an upper arm is connected to a positive side line of the inverter 30, and an emitter of the switching element Q22 of the upper arm is connected to a collector of the switching element Q24 of a lower arm. Further, the emitter of the switching element Q24 of the lower arm is connected to a negative side line of the inverter 30 and a negative pole of the battery 10. It is noted that the switching elements Q22 and Q24 may be transistors other than IGBTs, such as MOSFETs (metal oxide semiconductor field-effect transistor), etc.

The inverter 30 includes arms of U-V-W phases disposed in parallel between the positive side lines and the negative side line. The U-phase arm includes switching elements (IGBT in this example) Q1 and Q2 connected in series, the V-phase arm includes switching elements (IGBT in this example) Q3 and Q4 connected in series and the W-phase arm includes switching elements (IGBT in this example) Q5 and Q6 connected in series. Further, diodes D1-D6 are provided between collectors and emitters of corresponding switching elements Q1-Q6, respectively. It is noted that the switching elements Q1-Q6 may be transistors other than IGBTs, such as MOSFETs, etc.

The motor 40 is a three-phase permanent-magnet motor and one end of each coil of the U, V and W phases is commonly connected at a midpoint therebetween. The other end of the coil of U-phase is connected to a midpoint M1 between the switching elements Q1 and Q2, the other end of the coil of V-phase is connected to a midpoint M2 between the switching elements Q3 and Q4 and the other end of the coil of W-phase is connected to a midpoint M3 between the switching elements Q5 and Q6. A smoothing capacitor C2 is connected between a collector of the switching element Q1 and the negative electrode line. It is noted that the motor 40 may be a hybrid three-phase motor that includes an electromagnet and a permanent magnet in combination.

It is noted that, in addition to the motor 40, a second motor for driving a vehicle or a generator may be added in parallel with respect to the motor 40. In this case, a corresponding inverter may be added in parallel.

The semiconductor driver device 50 controls the DC/DC converter 20. It is noted that the semiconductor drive device 50 may control the inverter 30, in addition to the DC/DC converter 20. The semiconductor drive device 50 may be an ECU (Electronic Control Unit) that includes a microcomputer. Functions of the semiconductor drive device 50 (including functions described hereinafter) may be implemented by any hardware, any software, any firmware or any combination thereof. For example, the functions of the semiconductor drive device 50 may be implemented by an ASIC (application-specific integrated circuit) and a FPGA (Field Programmable Gate Array). Further, the functions of the ECU 50 may be implemented by a plurality of ECUs in cooperation.

A general way of controlling the DC/DC converter 20 may be arbitrary. Typically, the semiconductor drive device 50 controls the DC/DC converter 20 according to an operation state (a powering operation or a regenerating operation) of the inverter 30. For example, at the time of the powering operation, the semiconductor drive device performs the ON/OFF switching of only the switching element Q24 of the lower arm (i.e., a single-arm drive by the lower arm) to increase the voltage of the battery 10 and output the increased voltage to the side of the inverter 30. In this case, the switching element Q24 of the lower arm may be controlled with PMW (Pulse Width Modulation). Further, at the time of the regenerating operation, the semiconductor drive device 50 performs the ON/OFF switching of only the switching element Q22 of the upper arm (i.e., a single-arm drive by the upper arm) to decrease the voltage on the side of the inverter 30 and output the decreased voltage to the side of the battery 10. In this case, the switching element Q22 of the upper arm may be controlled with PMW. Further, the semiconductor drive device 50 may perform the ON/OFF switching of the switching elements Q22 and Q24 in a reversed phase (i.e., a double-arm drive) when the current flowing through the inductor L1 crosses 0 (at the time of a zero cross event).

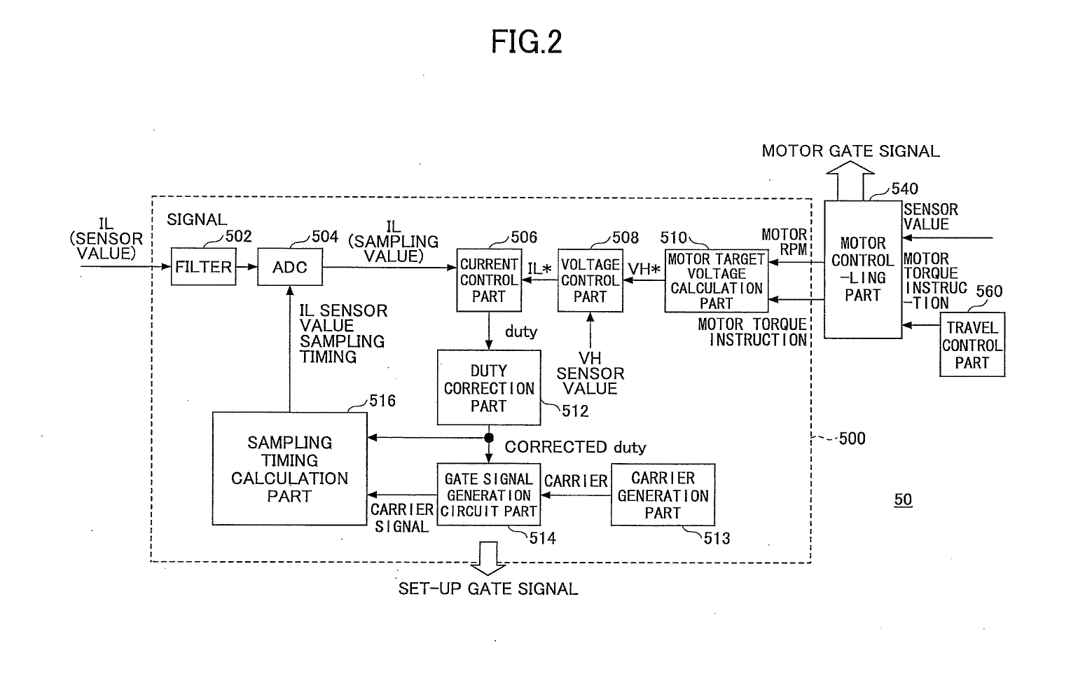

FIG. 2 is a diagram illustrating an example of a control block 500 of the DC/DC converter 20 of the semiconductor drive apparatus 50. It is noted that, in FIG. 2, parts (a motor control part 540 and a travel control part 560) related to the control block 500 of the DC/DC converter 20 are also illustrated. It is noted that the motor control part 540 and the travel control part 560 may be implemented by an ECU that implements the control block 500, or another ECU other than the ECU that implements the control block 500.

The travel control part 560 determines, based on an accelerator position and a vehicle speed, for example, a motor torque instruction value (target drive torque) to supply the determined value to the motor control part 540. The motor control part 540 may generate, based on the motor torque instruction value or sensor values (detection values of respective phase currents of current sensors, a detection value of a motor rpm of a resolver, for example), gate signals (motor gate signals) for the ON/OFF switching of the switching elements Q1 through Q6 of the inverter 30. The motor gate signals may be applied to the gates of the switching elements Q1 through Q6.

The control block of the DC/DC converter 20 includes a filter 502, an ADC (Analog to Digital Converter) 504, a current control part 506, a voltage control part 508, a motor target voltage calculation part 510, a duty correction part 512, a carrier generation part 513, a gate signal generation circuit part 514, and a sampling timing calculation part 516, as illustrated in FIG. 2.

A detection signal (analog signal) is input to the filter 502 from a current sensor (not illustrated) that detects a current (also referred to as “an inductor current IL”, hereinafter) flowing through the inductor L1. The filter 502 filters the detection signal to output the filtered signal to the ADC 504.

The ADC 504 is initiated at sampling timing generated by the sampling timing calculation part 516 such that ADC 504 samples the detection signal from the filter 502 at the sampling timing, thereby obtaining the sampled value (digital value) of the inductor current IL. The sampled value of the inductor current IL is supplied to the current control part 506.

The current control part 506 calculates the duty for driving (performing ON/OFF switching of) the switching elements Q22 and Q24 based on the sampled value of the inductor current IL from the ADC 504 and a target value IL* of the inductor current IL from the voltage control part 508. At that time, PI (Proportional Integral) control or PID (Proportional Integral Derivative) control may be used. The calculated duty is supplied to the duty correction part 512. It is noted that the target value IL* of the inductor current IL may be calculated in the voltage control part 508 based on a motor target voltage VH* and a detection value (VH sensor value) of the voltage VH across the smoothing capacitor C2. The motor target voltage VH* is a target value for the voltage VH across the smoothing capacitor C2. (see FIG. 1). The motor target voltage VH* may be calculated based on the motor rpm and the motor torque instruction value from the motor control part 540.

The duty correction part 512 corrects the duty from the current control part 506 to calculate a resultant duty (corrected duty). A way of correcting the duty by the duty correction part 512 is described hereinafter. The resultant duty is supplied to the sampling timing calculation part 516.

The carrier generation part 513 generates a reference signal with a predetermined frequency as a carrier signal. The carrier signal may have a waveform of a triangle wave or a rectangular wave. In the following, it is assumed that the carrier signal has the waveform of the triangle wave. The frequency of the carrier signal may be constant or varied. For example, the frequency of the carrier signal may be varied such that the frequency is decreased when a temperature of the DC/DC converter 20 is increased. The carrier signal is supplied to the gate signal generation circuit part 514 and the sampling timing calculation part 516.

The gate signal generation circuit part 514 generates, based on the carrier signal from the carrier generation part 513 and the duty from the duty correction part 512, gate signals for ON/OFF switching of the switching elements Q22 and Q24 of the DC/DC converter 20. The gate signals may be applied to the gates of the switching elements Q22 and Q24.

The sampling timing calculation part 516 determines, based on the carrier signal from the carrier generation part 513 and the duty from the duty correction part 512, the sampling timing for sampling (detecting) the inductor current IL, and transmits a signal, which represents the determined sampling timing, to the ADC 504. The sampling timing is determined such that one sampling is performed every ON/OFF switching cycle of the switching elements Q22 and Q24. In this case, the sampling timing is determined such that the average value of the current values of the inductor current IL during the corresponding ON/OFF period is sampled. An example of a way of determining the sampling timing is described hereinafter.

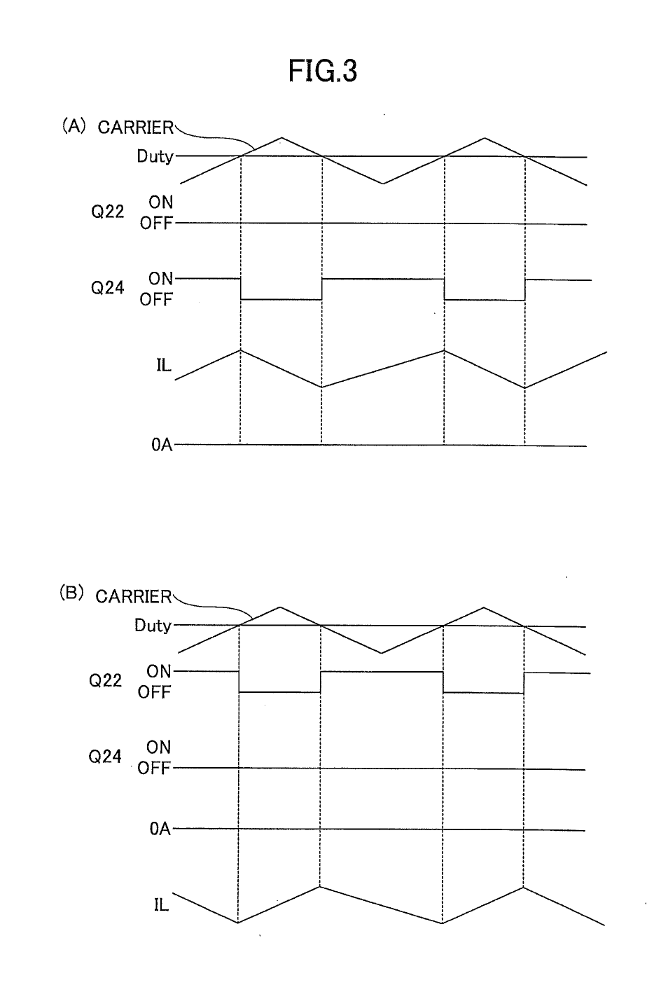

FIG. 3 is a diagram illustrating an example of time series of ON/OFF states of the switching elements Q22 and Q24 that are switched based on the carrier signal and the duty. In FIG. 3 (A), from an upper side, an example of a relationship between the carrier signal and the duty, an example of the ON/OFF states of the switching elements Q22 and Q24 at the time of the powering operation, and an example of a waveform of the inductor current IL are schematically illustrated. In FIG. 3 (B), from an upper side, an example of a relationship between the carrier signal and the duty, an example of the ON/OFF states of the switching elements Q22 and Q24 at the time of the regenerating operation, and an example of a waveform of the inductor current IL are schematically illustrated.

At the time of the powering operation, if the inductor current IL is greater than a predetermined threshold Th1, for example, only the switching element Q24 of the lower arm may be switched between the ON and OFF states while the switching element Q22 of the upper arm is kept in the OFF state, as illustrated in FIG. 3 (A) (i.e., the single-arm drive by the lower arm). In the example illustrated in FIG. 3 (A), the switching element Q24 of the lower arm is switched from the ON state to the OFF state when a level of the carrier signal exceeds a level of the duty, and switched from the OFF state to the ON state when the level of the carrier signal falls below the level of the duty.

When the switching element Q24 of the lower arm is turned ON, a current loop from the positive pole side of the battery 10 to the negative pole side of the battery 10 via the inductor L1 and the switching element Q24 is formed, which causes the inductor current IL to increase. At that time, the inductor current IL increases with a constant gradient, as illustrated in FIG. 3 (A). Next, when the switching element Q24 of the lower arm is turned off, the inductor L1 causes the current to continue to flow therethrough, which causes the current to flow to the side of the inverter 30 via the diode D22 of the upper arm. At that time, the inductor current IL decreases with a constant gradient, as illustrated in FIG. 3 (A). In this way, at the time of the powering operation, the inductor current IL alternately increases and decreases within a positive range while the gradient is changed at every ON/OFF switching event of the switching element Q24 of the lower arm. It is noted that the inductor current IL increases or decreases according to the duty such that the ON period of the switching element Q24 of the lower arm becomes longer, which causes the inductor current IL to increase, as the duty becomes greater.

At the time of the regenerating operation, if the inductor current IL is less than a predetermined threshold Th2, for example, only the switching element Q22 of the upper arm may be switched between the ON and OFF states while the switching element Q24 of the lower arm is kept in the OFF state, as illustrated in FIG. 3 (B) (i.e., the single-arm drive by the upper arm). It is noted that the predetermined value Th2 is negative, and may be −Th1, for example. In the example illustrated in FIG. 3 (B), the switching element Q22 of the upper arm is switched from the ON state to the OFF state when the level of the carrier signal exceeds the level of the duty, and switched from the OFF state to the ON state when the level of the carrier signal falls below the level of the duty.

When the switching element Q22 of the upper arm is turned ON, the current flows from the positive side of the inverter 30 to the positive pole side of the battery 10 via the switching element Q22 of the upper arm and the inductor L1. At that time, the inductor current IL decreases with a constant gradient (increases in a negative direction), as illustrated in FIG. 3 (B). Next, when the switching element Q22 of the upper arm is turned off, the inductor L1 causes the current to continue to flow therethrough, which causes the current to flow to the positive pole side of the battery 10 via the diode D24 of the lower arm. At that time, the inductor current IL increases with a constant gradient, as illustrated in FIG. 3 (B). In this way, at the time of the regenerating operation, the inductor current IL alternately increases and decreases within a negative range while the gradient is changed at every ON/OFF switching event of the switching element Q22 of the upper arm. It is noted that the inductor current IL increases or decreases according to the duty such that the ON period of the switching element Q22 of the upper arm becomes longer, which causes the inductor current IL to decrease (increase in the negative direction), as the duty becomes greater.

It is noted that, in the example illustrated in FIG. 3, the single-arm drive is illustrated as an example; however, the double-arm drive may be performed. At the time of the double-arm drive operation, the switching elements Q22 and Q24 are switched between the ON and OFF states in a reversed phase with an appropriate dead time therebetween. The double-arm drive operation may be performed when an absolute value of the inductor current IL is less than or equal to a predetermined value (Th1, for example), for example, or may be performed under other situations.

Further, in the example illustrated in FIG. 3, the duty is constant; however, the duty is changed (set) at a predetermined duty setting cycle that corresponds to a half cycle of the carrier signal. The duty may be changed at a crest of the carrier signal (i.e., the peak on the upper side) and a trough of the carrier signal (i.e., the peak on the lower side). In the following, as an example, it is assumed that the duty is changed at the crest and the trough of the carrier signal. It is noted that the duty calculated by the current control part 506 and the duty correction part 512 described above is used for the duty set at every duty setting cycle. Thus, the calculation of the duty by the current control part 506 and the duty correction part 512 is also performed at a cycle corresponding to the duty setting cycle, that is to say, once a half cycle of the carrier signal. Further, of course, the duty set at every duty setting cycle may be constant for the time being, depending on the duty calculated by the current control part 506 and the duty correction part 512.

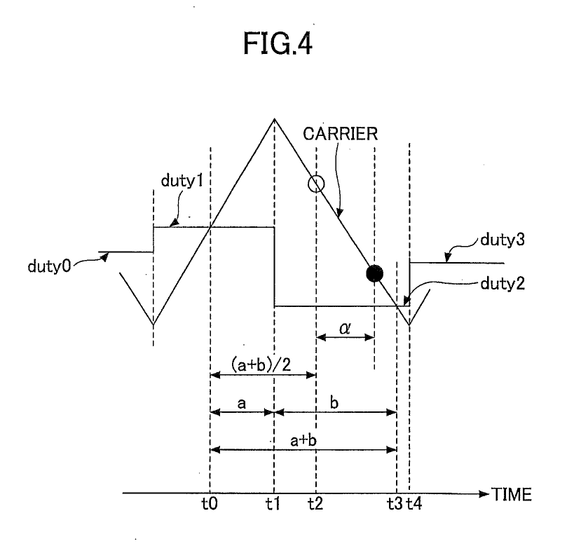

FIG. 4 is a diagram illustrating an example of a way of determining the sampling timing. In FIG. 4, the carrier signal, and levels according to the values of the duty (duty0, duty1, duty2, and duty3) calculated by the current control part 506 and the duty correction part 512 are illustrated. Here, as an example, the switching element Q22 (at the time of the regenerating operation illustrated in FIG. 3 (B)) is explained; however, the explanation may hold true for the switching element Q23 (at the time of the powering operation illustrated in FIG. 3 (A)). It is noted that at the time of the double-arm drive operation, the explanation may hold true for one of the switching elements Q22 and Q24.

In the example illustrated in FIG. 4, the level of the carrier signal exceeds the level of the duty at a time point t0, which causes the switching element Q22 to turn off, which in turn causes the OFF period to start. At a time point t1, the duty is changed (set) from the value “duty1” to the value “duty2) according to the occurrence of the crest of the carrier signal. At a time point t3, the level of the carrier signal falls below the level of the duty, which causes the switching element Q22 to turn on, which in turn causes the OFF period from time point t1 to end (i.e., the ON period to start). At a time point t4, the duty is changed (set) from the value “duty2” to the value “duty3) according to the occurrence of the trough of the carrier signal.

As described above, the sampling timing is determined such that the average value of the current values of the inductor current IL during the corresponding ON/OFF period is sampled.

Specifically, the sampling timing is set at a midpoint during the ON/OFF period. In the example illustrated in FIG. 4, the midpoint during the OFF period (from time point t0 to time point t3) this time corresponds to time point t2. In the example illustrated in FIG. 4, a position corresponding to the sampling timing is indicated by a white circle on the carrier signal. When the time from the start point of the OFF period (i.e., time point t0) to the crest of the carrier signal is “a”, and the time from the crest of the carrier signal to the end point of the OFF period (i.e., time point t3) is “b”, the sampling timing is set at a time point that is after the time “(a+b)/2” from the start point of the OFF period (i.e., time point t0).

It is noted that the midpoint during the ON/OFF period may mean a midpoint based on reverse timing the gate signals for the switching elements Q22 and Q24, or may strictly mean a midpoint based on the conducting states of the switching elements Q22 and Q24. Further, the sampling timing may be offset in a forward or backward direction with respect to the midpoint during the ON/OFF period. For example, the sampling timing may be set at a time point that is after a predetermined delayed time α from the midpoint during the ON/OFF period. In the example illustrated in FIG. 4, a position corresponding to the sampling timing set using the predetermined delayed time α is indicated by a black circle on the carrier signal. The predetermined delayed time α may correspond to a delayed time generated in the filter 502. In other words, because the detection signal of the current sensor is delayed when the detection signal passes through the filter 502, the sampling timing may be delayed with the predetermined delayed time α to reduce the influence by the delayed time at the filter 502.

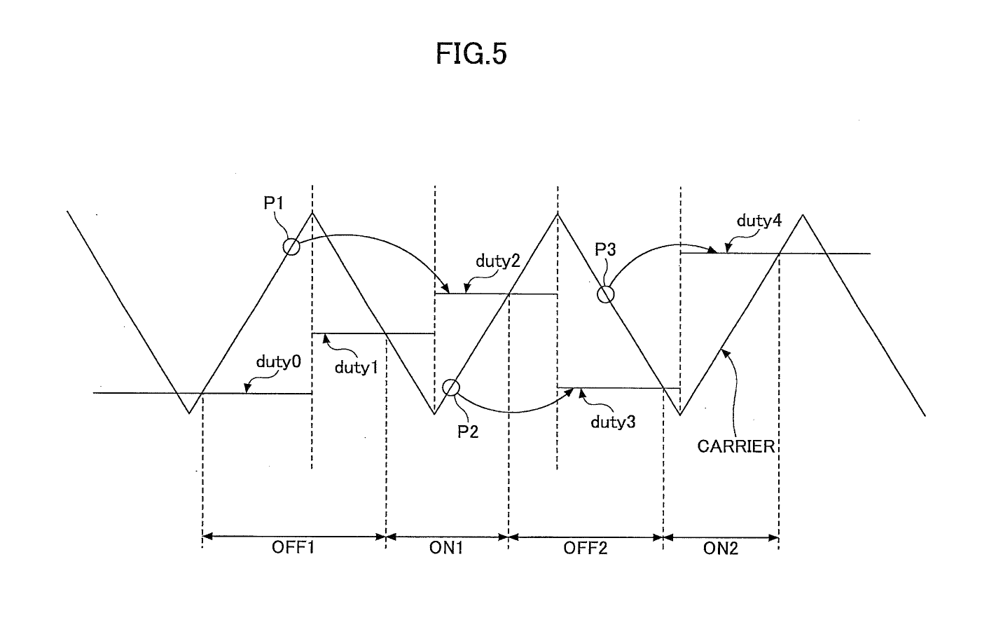

FIG. 5 is a diagram illustrating a relationship between respective sampling timings and values of the duty set based on sampled values of the inductor current IL obtained at the respective sampling timings.

In FIG. 5, the respective sampling timings P1, P2 and P3 are illustrated. The duty calculated based on the sampled value of the inductor current IL obtained at the sampling timing P1 during the OFF state “OFF1” is set as a “duty2” at a time point (at the trough of the carrier signal) during the next ON period “ON1”, as indicated by an arrow in FIG. 5. The value “duty2” is kept until a time point (the crest of the carrier signal) during the next OFF period “OFF2”. Further, the duty calculated based on the sampled value of the inductor current IL obtained at the sampling timing P2 during the ON state “ON1” is set as a “duty3” at a time point (at the crest of the carrier signal) during the next OFF period “OFF2”, as indicated by an arrow in FIG. 5. The value “duty3” is kept until a time point (the trough of the carrier signal) during the next ON period “ON2”. Further, the duty calculated based on the sampled value of the inductor current IL obtained at the sampling timing P3 during the OFF state “OFF2” is set as a “duty4” at a time point (at the trough of the carrier signal) during the next ON period “ON2”, as indicated by an arrow in FIG. 5. In this way, the sampled values of the inductor current IL sampled during the respective ON/OFF periods are used to calculate the duty set at the crest/trough of the carrier signal during the next ON/OFF periods.

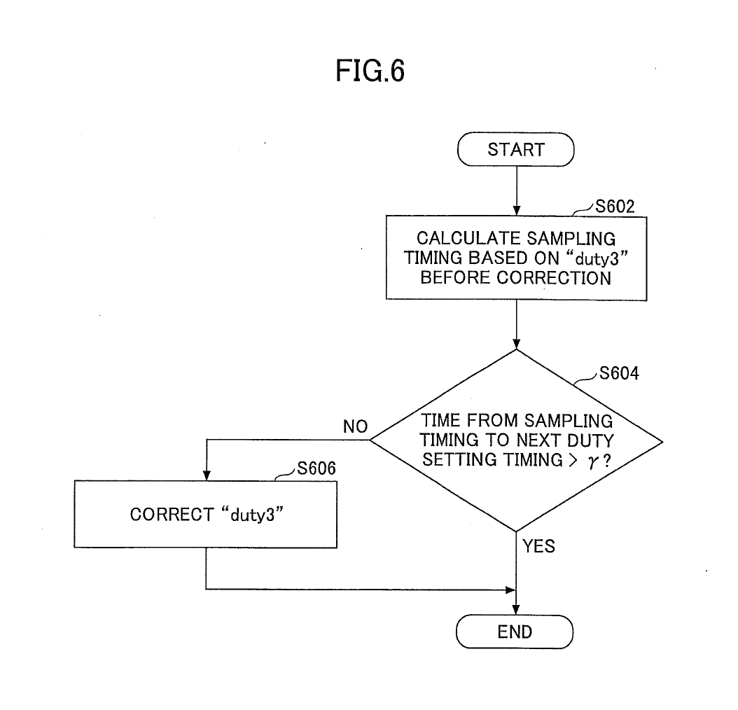

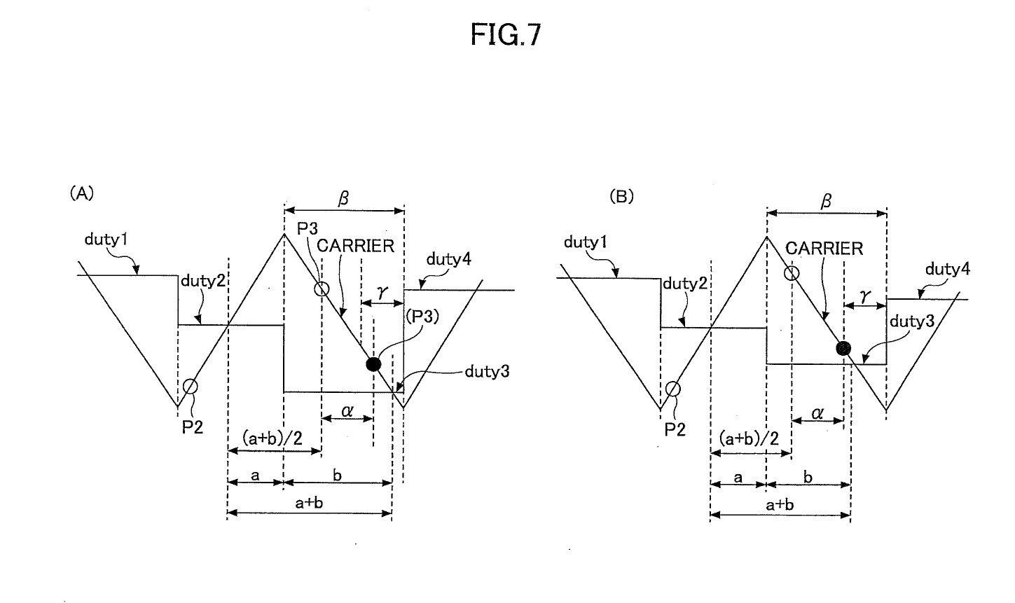

FIG. 6 is a diagram for explaining an example of a way of correcting the duty in the duty correction part 512. It is noted that a part or a whole of the process illustrated in FIG. 6 may be performed in coordination with the sampling timing calculation part 516. FIG. 7 is a diagram schematically illustrating a part of FIG. 5 to explain FIG. 6. Here, the correction of the value “duty3” is explained. FIG. 7 (A) illustrates the value “duty3” before the correction (the duty calculated by the current control part 506), and FIG. 7 (B) illustrates the value “duty3” after the correction (the duty corrected by the duty correction part 512).

Here, in FIG. 7 (A) and FIG. 7 (B), a time γ corresponds to a time required for the process from the sampling timing P3 to setting the resultant value of “duty4”, and is referred to as “a duty setting required time γ”, hereinafter. It is noted that a majority of the duty setting required time γ is occupied by a duty calculation process time required from the sampling timing P3 to the calculation of the resultant value of “duty4” by the duty correction part 512. The value of “duty3” before the correction is calculated based on the sampled value of the inductor current IL obtained at the sampling timing P2, as described above. For example, the current control part 506 calculates, based on the inductor current IL obtained at the sampling timing P2 and the target value IL* of the inductor current IL from the voltage control part 508, the value of “duty3” before the correction.

The process illustrated in FIG. 6 is performed at the time point or after the time point when the duty before the correction (the value of “duty3” before the correction, in this example) is calculated by the current control part 506 such that the process ends before the duty setting timing this time (until the next crest of the carrier signal, in this example). It is noted that, in the example illustrated in FIG. 6, the process illustrated in FIG. 6 is explained such that it is implemented by a software resource; however, a part or a whole of the process illustrated in FIG. 6 may be implemented by a hardware resource, etc., as described above.

In step S602, the next coming sampling timing P3 is calculated based on the value of “duty3” before the correction calculated by the current control part 506; the value of “duty2” that is currently set; and the current frequency of the carrier signal. Specifically, the duty correction part 512 calculates, based on the value of “duty2” that is currently set and the current frequency of the carrier signal, the value “a” (see FIG. 7 (A), etc.); calculates, based on the value of “duty3” before the correction calculated by the current control part 506 and the current frequency of the carrier signal (or the frequency of the carrier signal after the change if the frequency is to be changed from the next crest), the value “b” (see FIG. 7 (A), etc.); and calculates the value “(a+b)/2” (see FIG. 7 (A), etc.) (see the white circle P3 in FIG. 7). It is noted that, as described above, in the case of considering the delayed time, the sampling timing is calculated as “(a+b)/2+α” (see the black circle P3 in FIG. 7).

In step S604, it is determined whether the time from the next coming sampling timing to the next duty setting timing (the next trough of the carrier signal) is greater than or equal to the duty setting required time γ. For example, if the sampling timing is determined as “(a+b)/2+α” (see black circle P3 in FIG. 7), it is determined whether the following relationship is met.

B−{(a+b)/2−a}≧γ formula (1)

It is noted that “{(a+b)/2−a}” represents a time from the crest of the carrier signal to the next coming sampling timing P3, and β represents a time from the crest to the trough of the carrier signal. β changes according to the frequency of the carrier signal, and thus β may be changed according to the current frequency of the carrier signal (or the frequency of the carrier signal after the change, if the frequency is to be changed at the next crest). For example, if the sampling timing is determined as “(a+b)/2+α” (see black circle P3 in FIG. 7), it is determined whether the following relationship is met.

β−{(a+b)/2−a+α}≧γ formula (2)

In step S604, if the time from the next coming sampling timing P3 to the next duty setting timing is greater than or equal to the duty setting required time γ, the process routine directly ends. In other words, in such a case, it is determined that it is not necessary to correct the value “duty3” before the correction, and thus the process routine ends without correcting the value “duty3” before the correction. In such a case, the value “duty3” before the correction is set as it is at the next duty setting timing (the next trough of the carrier signal). On the other hand, if the time from the next coming sampling timing P3 to the next duty setting timing is not greater than or equal to the duty setting required time γ, the process routine goes to step S606.

In step S606, the value “duty3” before the correction is corrected. Specifically, the value “duty3” before the correction is corrected such that the time from the next coming sampling timing P3 to the next duty setting timing is greater than or equal to the duty setting required time γ. For example, if the sampling timing is determined as “(a+b)/2” (see white circle P3 in FIG. 7), the duty corresponding to the maximum of the value “b” that meets the relationship of the formula (1) may be determined as the value “duty3” after the correction. For example, if the sampling timing is determined as “(a+b)/2+α” (see black circle P3 in FIG. 7), the duty corresponding to the maximum of the value “b” that meets the relationship of the formula (2) may be determined as the value “duty3” after the correction.

It is noted that, in the example illustrated in FIG. 7 (A), if the sampling timing is determined as “(a+b)/2+α”, the time from the next coming sampling timing P3 (see black circle P3 in FIG. 7) to the next duty setting timing (the next trough of the carrier signal) is less than the duty setting required time γ, which causes the process routine to go to step S606 where the value “duty3” before the correction is corrected. As a result of this correction, as illustrated in FIG. 7 (B), the time from the next coming sampling timing P3 (see black circle P3 in FIG. 7) to the next duty setting timing (the next trough of the carrier signal) becomes greater than or equal to the duty setting required time γ.

In this way, according to the way of correcting the duty illustrated in FIG. 6, if the time from the next coming sampling timing P3 to the next duty setting timing is less than the duty setting required time γ, the resultant duty to be set at the current duty setting timing is determined such that the time from the next coming sampling timing P3 to the next duty setting timing is greater than or equal to the duty setting required time γ. Therefore, it becomes possible to complete the calculation of the duty (the value “duty4” in this example), which is to be calculated based on the sampling value of the inductor current IL at the next coming sampling timing P3 and to be set at the next duty setting timing, before the next duty setting timing. Specifically, if the correction described above is not performed, even if the value “duty4” is calculated based on the sampling value of the inductor current IL at the sampling timing, there may be a problem that such calculation of the value “duty4” is not completed before the next duty setting timing (as a result of this, there may be a case where the duty cannot be newly set). In contrast, the duty correction process illustrated in FIG. 6 can reduce such a problem.

It is noted that, the way of correcting the duty, which is to be set at the crest of the carrier signal, is explained with reference to FIG. 6 and FIG. 7, however, the same holds true for a way of correcting the duty to be set at the trough of the carrier signal. For example, the same can be applied to the duty (the value “duty4”) which is to be calculated based on the sampling value of the inductor current IL at the coming sampling timing P3.

Further, in FIG. 6 and FIG. 7, the upper limit and the lower limit of the duty are not considered; however, as described hereinafter, the upper limit and the lower limit of the duty may be used to correct the duty.

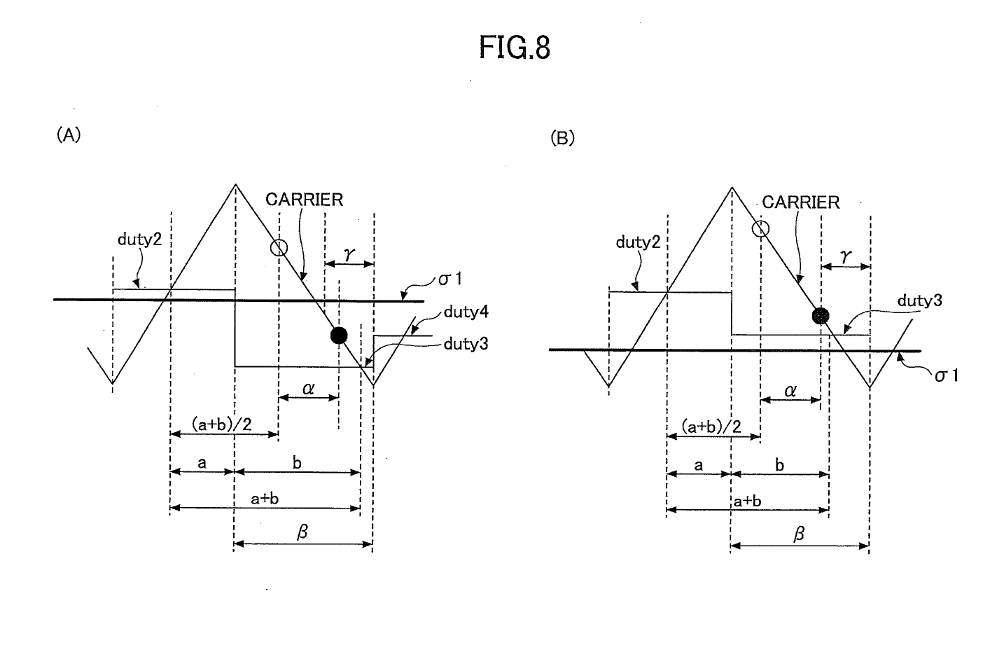

FIG. 8 is a diagram of explaining a way of correcting the duty, which is to be set at the crest of the carrier signal, with a lower limit σ1 thereof. The duty corresponding to the maximum of the value “b” that meets the relationship of the formula (1) or (2) is referred to as “a critical point duty”, hereinafter. FIG. 8 (A) illustrates a case where the lower limit σ1 of the duty is greater than the critical point duty, and FIG. 8 (B) illustrates a case where the lower limit σ1 of the duty is less than the critical point duty. The lower limit σ1 of the duty is physically required to avoid a short circuit, and may be varied according to a dead time, the frequency of the carrier signal, etc.

As illustrated in FIG. 8 (A), if the lower limit σ1 of the duty is greater than the critical point duty, the duty may be corrected such that the duty is greater than or equal to the lower limit σ1. On the other hand, if the lower limit σ1 of the duty is less than the critical point duty, the duty may be corrected such that the duty is greater than or equal to the critical point duty.

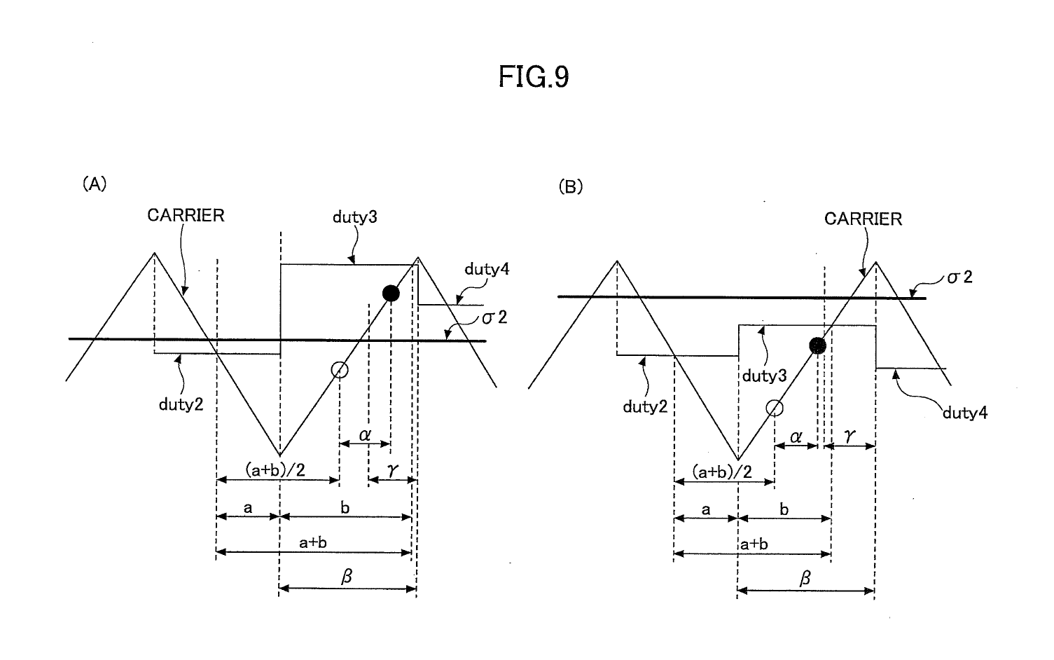

FIG. 9 is a diagram of explaining a way of correcting the duty, which is to be set at the trough of the carrier signal, with an upper limit σ2 thereof. FIG. 9 (A) illustrates a case where the upper limit σ2 of the duty is less than the critical point duty, and FIG. 9 (B) illustrates a case where the upper limit σ2 of the duty is greater than the critical point duty. As is the case with the lower limit σ1, the upper limit σ2 of the duty is a physically required to avoid a short circuit, and may be varied according to a dead time, the frequency of the carrier signal, etc.

As illustrated in FIG. 9 (A), if the upper limit σ2 of the duty is less than the critical point duty, the duty may be corrected such that the duty is less than or equal to the upper limit σ2. On the other hand, if the upper limit σ2 of the duty is greater than the critical point duty, the duty may be corrected such that the duty is less than or equal to the critical point duty.

The present invention is disclosed with reference to the preferred embodiments. However, it should be understood that the present invention is not limited to the above-described embodiments, and variations and modifications may be made without departing from the scope of the present invention.

For example, according to the embodiment described above, if the time from the next coming sampling timing P3 to the next duty setting timing is less than the duty setting required time γ, the duty (critical point duty), which corresponds to the maximum of the value “b” that meets the relationship of the formula (1) or (2), is set such that the time from the next coming sampling timing P3 to the next duty setting timing is equal to the duty setting required time γ; however, the duty other than the critical point duty may be set such that the time from the next coming sampling timing P3 to the next duty setting timing is greater than the duty setting required time γ. For example, at the time of correcting the duty to be set at the crest of the carrier signal, the duty may be corrected to a value which is slightly greater than the critical point duty. Further, at the time of correcting the duty to be set at the trough of the carrier signal, the duty may be corrected to a value which is slightly less than the critical point duty.

Further, according to the embodiment described above, the duty is set at every peak (the crest and the trough) of the carrier signal; however, the duty may be set at timing which is shifted from the peak of the carrier signal by a predetermined phase.

Further, according to the embodiment described above, the DC/DC converter 20 is the bidirectional DC-DC converter; however, a type of the converter is arbitrary. For example, the DC/DC converter 20 may be of a type which can perform only the step-up conversion, or may be of a type which can perform the step-down conversion. For example, in the case of the converter that can perform only the step-up conversion, the upper arm may include only the diode D22 without the switching element Q22. Further, in the case of the converter that can perform only the step-down conversion, the lower arm may include only the diode D24 without the switching element Q24.

Further, according to the embodiment described above, the resultant duty is determined by the duty correction part 512 that corrects the duty calculated by the current control part 506; however, the current control part 506 may include the function of the duty correction part 512. For example, the current control part 506 may use the critical point duty as the upper or lower limit of the duty to determine the duty based on the sampling value of the inductor current IL from the ADC 504 and the target value IL* of the inductor current IL from the voltage control part 508.

Further, according to the embodiment described above, the DC/DC converter 20 is used for the vehicle; however, the DC/DC converter 20 may be used for another application (a power supply apparatus for another motor-operated apparatus, for example). Further, the DC/DC converter 20 may be used for another application in the vehicle (for an electric power steering system, for example).

The present application is based on Japanese Priority Application No. 2012-271390, filed on Dec. 12, 2012, the entire contents of which are hereby incorporated by reference.

1. A converter apparatus, comprising:
a converter that includes a switching element and an inductor;
a controller that sets a duty at a predetermined duty setting cycle, and executes an ON/OFF switching of the switching element of the converter at switching timing according to a relationship between the set duty and a carrier signal, the predetermined duty setting cycle corresponding to a half cycle of the carrier signal, wherein
the controller determines the duty to be set at this duty setting cycle such that sampling of a current value of a current flowing through the inductor and calculation of the duty to be set at the next duty setting cycle based on the sampled current value are completed before next duty setting timing.

2. The converter apparatus of claim 1, wherein the controller determines the duty to be set at this duty setting cycle such that a time from sampling timing of the current value of the current flowing through the inductor to the next duty setting timing is greater than or equal to a predetermined time.

3. The converter apparatus of claim 1, wherein sampling timing of the current value of the current flowing through the inductor is determined such that an average value of the current flowing through the inductor over a single ON period or OFF period of the switching element is sampled.

4. The converter apparatus of claim 1, wherein sampling timing of the current value of the current flowing through the inductor is determined based on the duty set at the previous duty setting cycle and the duty to be set at this duty setting cycle.

5. The converter apparatus of claim 4, wherein sampling timing of the current value of the current flowing through the inductor corresponds to a midpoint between the previous switching timing according to the duty set at the previous duty setting cycle and the switching timing according to the duty to be set at this duty setting cycle.

6. The converter apparatus of claim 4, wherein sampling timing of the current value of the current flowing through the inductor corresponds to timing after a predetermined delayed time from a midpoint, the midpoint being between the previous switching timing according to the duty set at the previous duty setting cycle and the switching timing according to the duty to be set at this duty setting cycle.
